(19) United States
(12) Patent Application Publication
(10) Pub. No.: US 2015/0050069 A1
(43) Pub. Date: Feb. 19, 2015

(54) SWIVELLING JOINT

(71) Applicant: Swivelpole Patent Pty Ltd, Mandurah (AU)

(72) Inventors: Robert John Pannekoek, Mandurah (AU); Peter Pannekoek, Mandurah (AU)

(21) Appl. No.: 14/391,774

(22) PCT Filed: Apr. 12, 2013
(86) PCT No.: PCT/AU2013/000374

§ 371 Date: Oct. 10, 2014

(30) Foreign Application Priority Data
Apr. 12, 2012 (AU) 2012901434

(51) Int. Cl. F21V 21/28; F21V 21/36; F21V 21/10

(52) U.S. Cl. CPC F21V 21/28; F21V 21/10; F21V 21/36
USPC 403/57

(57) ABSTRACT

A swivelling joint is disclosed primarily for use in light poles. The swivelling joint includes two annular bearing faces oriented at 45° to a longitudinal axis of the joint, and a central bolt passing through the bearing faces to hold the joint in position.

### FIELD OF THE INVENTION

The present invention relates to a swivelling joint for use in light poles and similar structures. The swivelling joint is expected to be used in light poles in excess of 2 m in height, or light poles having a light located outside of easy reach. It is anticipated that the swivelling joint may be used in other poles such as flag poles, or in raised elongate structures.

BACKGROUND TO THE INVENTION

The Swivelpole™ is described in the International Patent Application published as WO0125687, the contents of which are incorporated herein by reference. This product consists of a light pole which has a swivelling joint along its length. The swivelling joint allows for safer and easier changing and repair of lights than had previously been available.

The Swivelpole™ has proved highly successful, and has become an important safety feature in many industrial, mining, and oil-and-gas installations. Nonetheless, some limitations have been identified in both the manufacture and use of the product.

The Swivelpole™ requires precise welding of flat plates onto tubing. Such welding requires considerable expertise, in addition to costly equipment. Inexpert welding can lead to distortion of the flat plates, resulting in an underperforming joint. It is considered desirable to have a joint which could be formed without welding, for instance by casting and machining. The Swivelpole™ cannot be easily formed by such a method.

In addition, by the nature of its design, the Swivelpole™ includes an open joint into which water and dust can locate. This is problematic in some applications.

In order to operate the Swivelpole™, four separate bolts must be loosened, and a pin removed. The four bolts must then be tightened following use of the joint. Although this system of operation has proved highly successful and efficient, it is considered that further improvements in efficiency may be possible.

The present invention seeks to improve some features of the previous Swivelpole™ design, particularly to allow for easier manufacture, whilst retaining the key concept of the swivelling joint.

### SUMMARY OF THE INVENTION

According to one aspect of the present invention there is provided a swivelling joint including a first member, a second member, and a connector;
the first member having a longitudinally extending leg and a connecting portion, the connecting portion including a bearing surface which is oriented at an acute angle relative to the longitudinally extending leg, the bearing surface having a circular outer edge;
the second member having a longitudinally extending leg and a connecting portion, the connecting portion including: a bearing surface which is oriented at an acute angle relative to the longitudinally extending leg, the bearing surface having a circular outer edge; and a cylindrical sleeve which projects from the circular outer edge in a direction generally perpendicular to the bearing surface;
the connector coupling the first and second members to each other such that the bearing surface of the first member bears against the bearing surface of the second member, with the sleeve of the second member locating around the circular outer edge of the bearing surface of the first member;
and wherein the connector permits rotation of the first member relative to the second member between a first position in which the longitudinally extending leg of the first member is parallel to the longitudinally extending leg of the second member and a second position in which the longitudinally extending leg of the first member is angled with respect to the longitudinally extending leg of the second member.

According to a second aspect of the present invention there is provided a swivelling joint including a first member, a second member, and a connector;
the first member having a longitudinally extending leg and a connecting portion, the connecting portion including a bearing surface which is oriented at an acute angle relative to the longitudinally extending leg, the bearing surface having an outer edge;
the second member having a longitudinally extending leg and a connecting portion, the connecting portion including: a bearing surface which is oriented at an acute angle relative to the longitudinally extending leg, the bearing surface having an outer edge; and a sleeve which projects from the outer edge;
the connector coupling the first and second members to each other such that the bearing surface of the first member faces the bearing surface of the second member, with the sleeve of the second member locating around the outer edge of the bearing surface of the first member;
and wherein the connector permits rotation of the first member relative to the second member between a first position in which the longitudinally extending leg of the first member is parallel to the longitudinally extending leg of the second member and a second position in which the longitudinally extending leg of the first member is angled with respect to the longitudinally extending leg of the second member.

According to a third aspect of the present invention there is provided a swivelling joint including a first member, a second member, and an axle;
the first member having a longitudinally extending leg and a connecting portion, the connecting portion including a bearing surface which is oriented at an acute angle relative to the longitudinally extending leg;
the second member having a longitudinally extending leg and a connecting portion, the connecting portion including a bearing surface which is oriented at an acute angle relative to the longitudinally extending leg;
the first and second members being coupled to each other such that the bearing surface of the first member faces the bearing surface of the second member;
the axle being arranged to pass through the connecting portion of the first member and the second member in a direction generally perpendicular to the bearing surface of the first member; and
the first and second members being coupled to each other so as to permit rotation of the first member relative to the second member about the axle between a first position in which the longitudinally extending leg of the first member is parallel to the longitudinally extending leg of the second member and a second position in which the longitudinally extending leg of the first member is angled with respect to the longitudinally extending leg of the second member.

According to a fourth aspect of the present invention there is provided a swivelling joint including a first member, a second member, and a connector;
the first member having a longitudinally extending leg and a connecting portion, the connecting portion including a bearing surface which is oriented at an acute angle relative to the longitudinally extending leg;
the second member having a longitudinally extending leg and a connecting portion, the connecting portion including a bearing surface which is oriented at an acute angle relative to the longitudinally extending leg;
the connector coupling the first and second members to each other such that the bearing surface of the first member bears against the bearing surface of the second member;
the connector permitting rotation of the first member relative to the second member between a first position in which the longitudinally extending leg of the first member is parallel to the longitudinally extending leg of the second member and a second position in which the longitudinally extending leg of the first member is angled with respect to the longitudinally extending leg of the second member;
wherein the connector is elongate, and defines an axis about which the relative rotation of first and second members can take place.

The swivelling joint may be incorporated within a pole such as a light pole, with one of the legs extending from the ground and the other leg ending at, for instance, a light fixture. Alternatively, the swivelling joint may be provided with relatively short legs, each leg being arranged to mount to another fixture.

It is preferred that the acute angle formed by the bearing surface in the first member is the same as that formed by the bearing surface in the second member. While this angle is preferably in the range 30° to 60°, it is considered that an angle of 45° is particularly useful.

It is preferred that the connector be adjustable between a free configuration in which relative rotation of the first and second members is permitted and a fixed configuration in which relative rotation of the first and second members is restricted. In a preferred embodiment of the invention the connector in its fixed configuration provides a compressive force between the first and second members, urging the respective bearing surfaces into contact and using friction to restrict rotation. In this embodiment the connector may be formed by a bolt extending through apertures in the first and second members, whereby movement between free and fixed configurations can be effected by tightening or loosening of the bolt. The bolt may have a nut and preferably a washer at its outer end. Alternatively, one of the first and second members may include an internally threaded aperture in which the bolt is received.

In this embodiment the bolt may act as an axle about which at least one of the first and second members may rotate when the connector is in the free configuration. Alternatively, the bolt may have a smaller diameter than the apertures, with the sleeve acting as a bearing bush to support the rotation.

The bearing surfaces are preferably annular. In a preferred embodiment, the bearing surfaces are annular with an internal diameter sized between 20% and 85% of the external diameter, and more preferably an internal diameter sized between 50% and 70% of the external diameter. The arrangement is such that the centres of the bearing surfaces align to create an aperture through which wires or similar can pass, such as cabling for an electric light.

The swivelling joint may include a latch. It is preferred that the latch includes a pin extending from one of the first and second members into a receptacle within the other of the first and second members. The receptacle is usefully provided as an aperture within the relevant bearing surface. It is preferred that at least two apertures be provided, one corresponding to the first position of the swivelling joint and the other corresponding to the second position of the swivelling joint. It may be desirable for the swivelling joint to move between several interim positions between the first and second position, and thus there may be several further apertures provided. In a preferred embodiment there is one aperture provided corresponding to the first position of the pivoting joint, and between four and eight apertures provided near the second position, corresponding to angles of between 45° and 90° of the longitudinally extending leg of the first member with respect to the longitudinally extending leg of the second member.

The pin may be located within a pin housing, and moveable between an extended position in which it locates within a receptacle and a withdrawn position in which it is retracted from the receptacle to permit relative rotation of the first and second members. Resilient biasing means such as a spring may be provided to urge the pin into the extended position. In a preferred embodiment the pin housing includes means to translate rotation of an outer activator into linear movement of the pin. This may be effected through a rack-and-pinion mechanism or similar, or through a threaded connection between pin and housing.

The latch may also include a locking means to prevent inadvertent operation of the latch. In one embodiment the locking means is formed by a projection within the pin, arranged to move laterally of the pin to prevent retraction of the pin from the receptacle.

### BRIEF DESCRIPTION OF THE DRAWINGS

It will be convenient to further describe the invention with reference to preferred embodiments of the present invention. Other embodiments are possible, and consequently the particularity of the following discussion is not to be understood as superseding the generality of the preceding description of the invention. In the drawings:

FIG. 1 is a perspective of a swivelling joint in accordance with the present invention, shown in a first position;

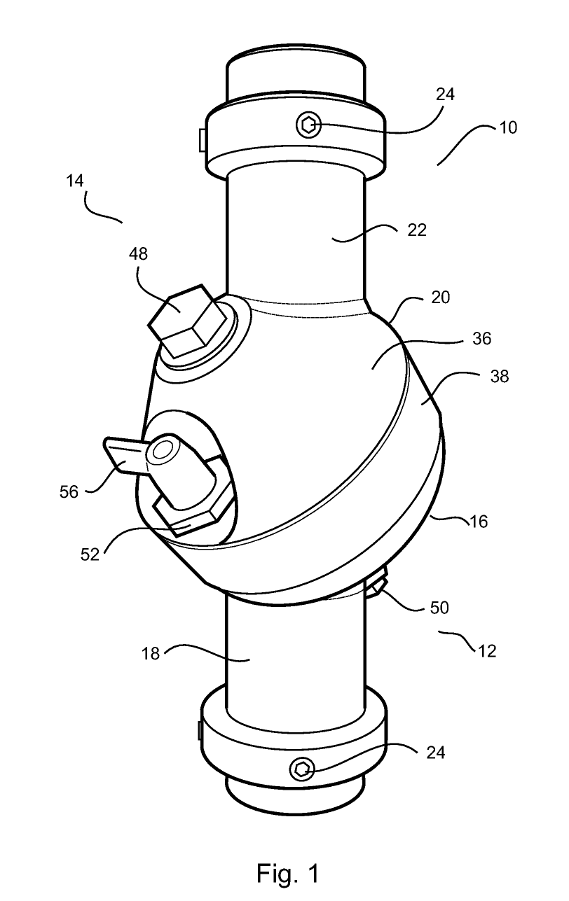

FIG. 2 is a perspective of the swivelling joint of FIG. 1, shown in a second position;

FIG. 3 is a perspective of a first member of the swivelling joint of FIG. 1;

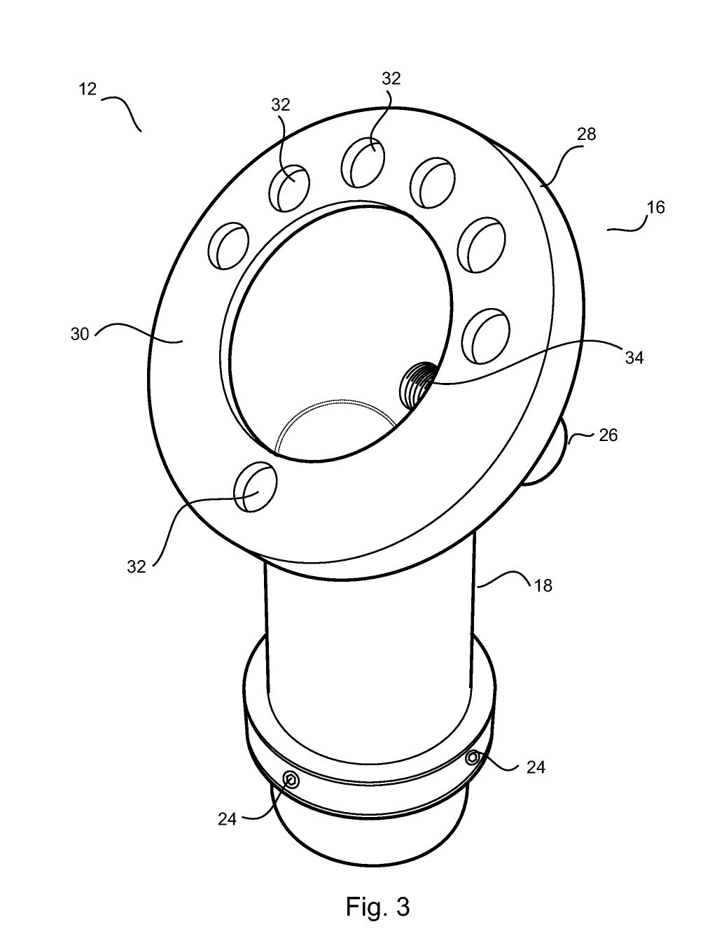

FIG. 4 is an exploded view of the swivelling joint of FIG. 1;

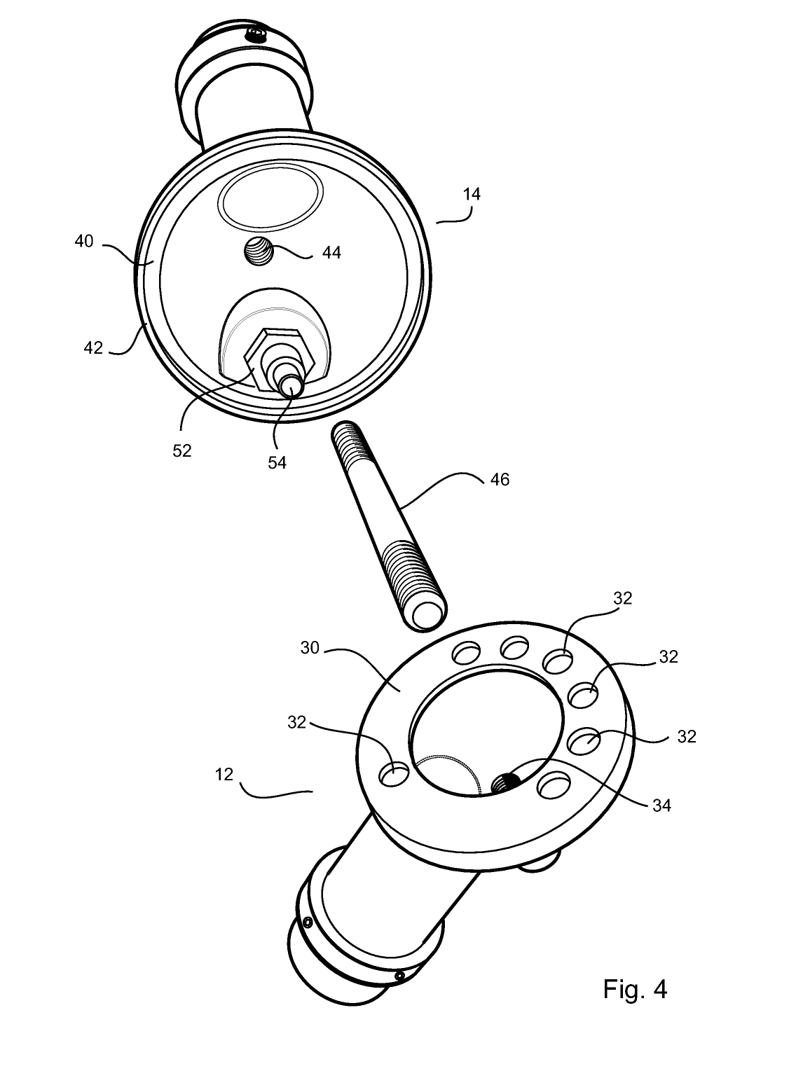

FIG. 5 is a perspective of a second member of the swivelling joint of FIG. 1;

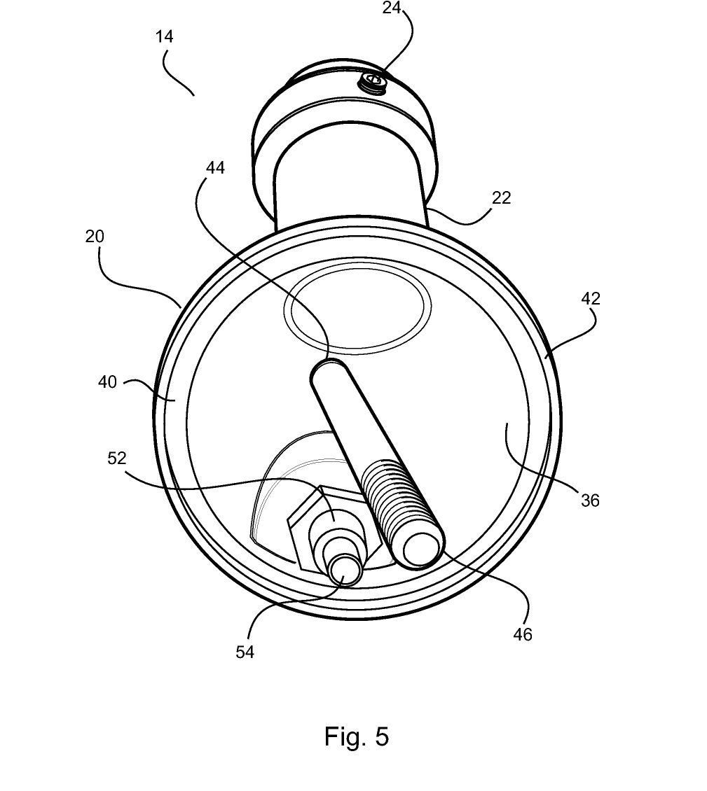

FIG. 6 is a cross section through the swivelling joint of FIG. 1 shown in the first position; and

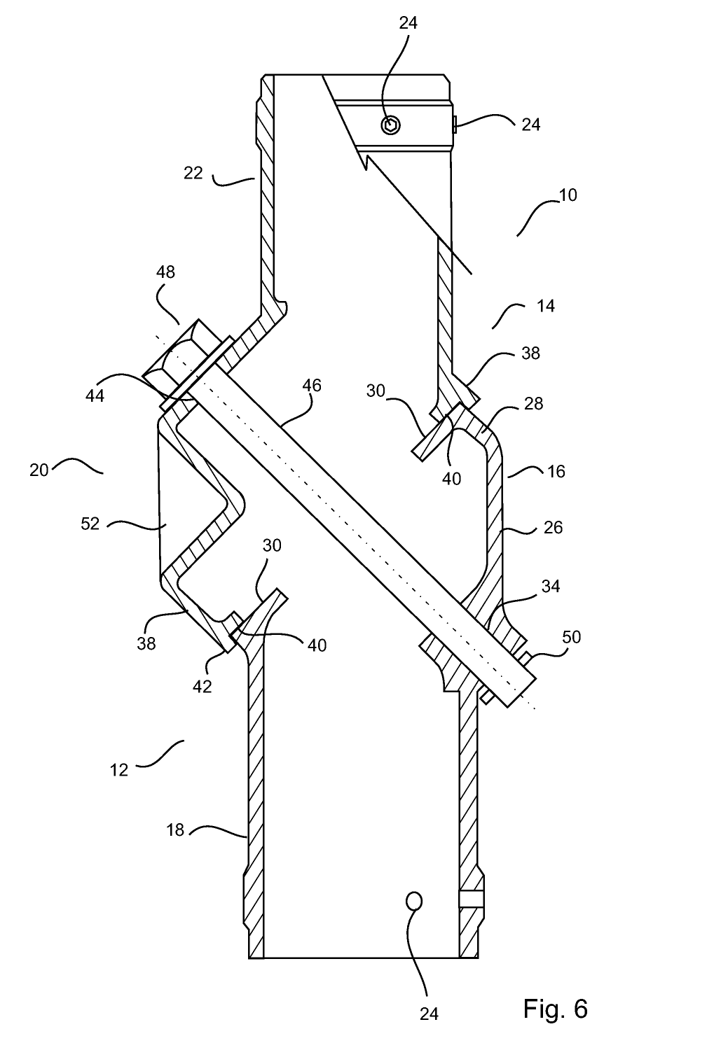

FIG. 7 is a cross section through the swivelling joint of FIG. 1 shown in the second position.

### DETAILED DESCRIPTION OF PREFERRED EMBODIMENTS

Referring to the figures, there is shown a swivelling joint 10 having a first member 12 and a second member 14.

The first member 12 has a bulbous connection portion 16 and a first elongate leg 18. The second member 14 has a bulbous connection portion 20 and a second elongate leg 22.

Each of the first and second legs 18, 22 extend from their associated connection portion 16, 20 a short distance, for instance about 15 cm. Each of the first and second legs 18, 22 has a number of circumferentially spaced grub screw receiving apertures 24 close to its outer end for attachment to coaxial poles.

The connection portion 16 of the first member 12 includes a generally conical portion 26 connected to a generally cylindrical portion 28. The conical portion 26 and cylindrical portion 28 share a common axis. This axis is oriented at 45° to an axis of the first elongate leg 18.

The cylindrical portion 28 terminates in an annular bearing surface 30, which extends radially internally of the cylindrical portion 28. The annular bearing surface 30 is perpendicular to the axis of the cylindrical portion 28, and thus is oriented at 45° to the axis of the first elongate leg 18.

The annular bearing surface 30 includes a plurality of apertures 32 spaced circumferentially around it.

The connection portion 16 also includes an internally threaded, bolt-receiving aperture 34 located at an apex of the conical portion 26. The bolt receiving aperture 34 is coaxial to the conical portion 26.

The connection portion 20 of the second member 14 includes a generally conical portion 36 connected to a generally cylindrical portion 38. The conical portion 36 and cylindrical portion 38 share a common axis. This axis is oriented at 45° to an axis of the first elongate leg 18.

The conical portion 36 of the second member 14 is of similar size and shape to the conical portion 26 of the first member 12. The cylindrical portion 38 of the second member 14 is slightly greater in outside diameter than the cylindrical portion 28 of the first member 12, and about twice the length.

The cylindrical portion 38 terminates in an annular bearing surface 40, which extends radially internally of the cylindrical portion 38, and a cylindrical sleeve 42 which extends axially a short distance from an outer edge of the bearing surface 40. The annular bearing surface 40 is perpendicular to the axis of the cylindrical portion 38, and thus is oriented at 45° to the axis of the second elongate leg 22. The annular bearing surface 40 of the second member 14 has the same outer diameter as that of the annular bearing surface 30 of the first member 12, but has a significantly larger internal diameter. As a result, the width of the annular bearing surface 40 of the second member 14 is about one quarter that of the annular bearing surface 30 of the first member 12.

The connection portion 20 also includes an internally threaded, bolt receiving aperture 44 located at an apex of the conical portion 36. The bolt receiving aperture 44 is coaxial to the conical portion 36.

The arrangement is such that when the second member 14 is placed over the first member 12, the bearing surface 40 of the second member 14 acts against the bearing surface 30 of the first member 12. The sleeve 42 locates around an outer end of the cylindrical portion 28 of the first member 12. The respective bolt receiving apertures 34, 44 are aligned, such that a connector bolt 46 can extend through the joint 10 with its ends received in the bolt receiving apertures 34, 44.

The connector bolt 46 has a head 48 which locates outside the second member 14. The connector bolt 46 has a receiving nut 50 which locates outside the first member 12.

The second member 14 also includes a pin housing 52 located within the connection portion 20, radially internal of and close to the annular bearing surface 40. The pin housing 52 locates a pin 54, which is parallel to the bolt 46.

The pin 54 is connected to a lever 56 located externally of the connection portion 20. A mechanism such as a rack-and-pinion mechanism (not shown) translates rotation of the lever 56 into lateral movement of the pin 54 between a latched position in which the pin projects into an aperture 32 of the bearing surface 30 of the first member 12, and a released position in which the pin is withdrawn behind the plane defined by the bearing surface 40 of the second member 14. A torsion spring is supplied into the pin housing 52, to urge the pin into the latched position.

In an alternative embodiment (not shown), the pin 54 includes an additional locking means, such as a laterally moveable projection or detent which is located at an end of the pin 54, and which when engaged prevents retraction of the pin 54 through the aperture 32.

In use, the swivelling joint 10 is arranged with the first elongate leg 18 mounted at a convenient working height to a vertical pole by means of grub screws in the apertures 24. The second member 14 is connected to the first member 12 by means of the bolt 46 as described above, and the second elongate leg 22 is connected to another vertical pole on which is mounted a light fitting at a height beyond easy reach. The swivelling joint is maintained in its first position, with the first and second elongate legs 18, 22 perpendicular and, indeed, co-axial.

The swivelling joint 10 is held in a fixed configuration by tightening of the bolt 46. Tightening of the bolt 46 causes a compressive force between the bearing surfaces 30, 40, and the resulting friction prevents rotation of the second member 14 about the first member 12.

In addition, the swivelling joint 10 is held in a latched position, with the pin 54 extending through an aperture 32 of the bearing surface 30 and also acting to prevent rotation of the second member 14 about the first member 12.

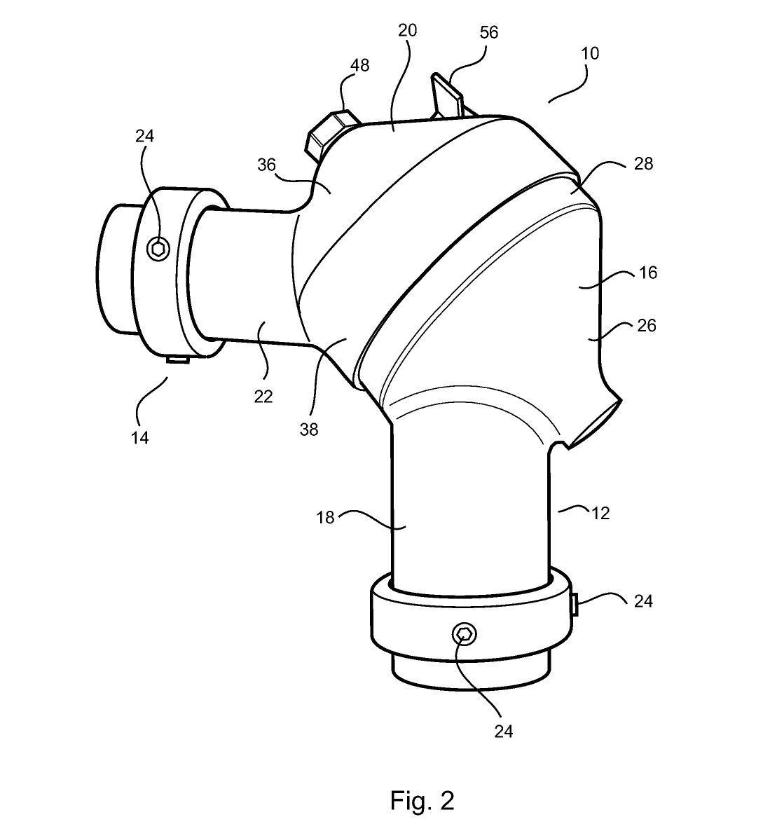

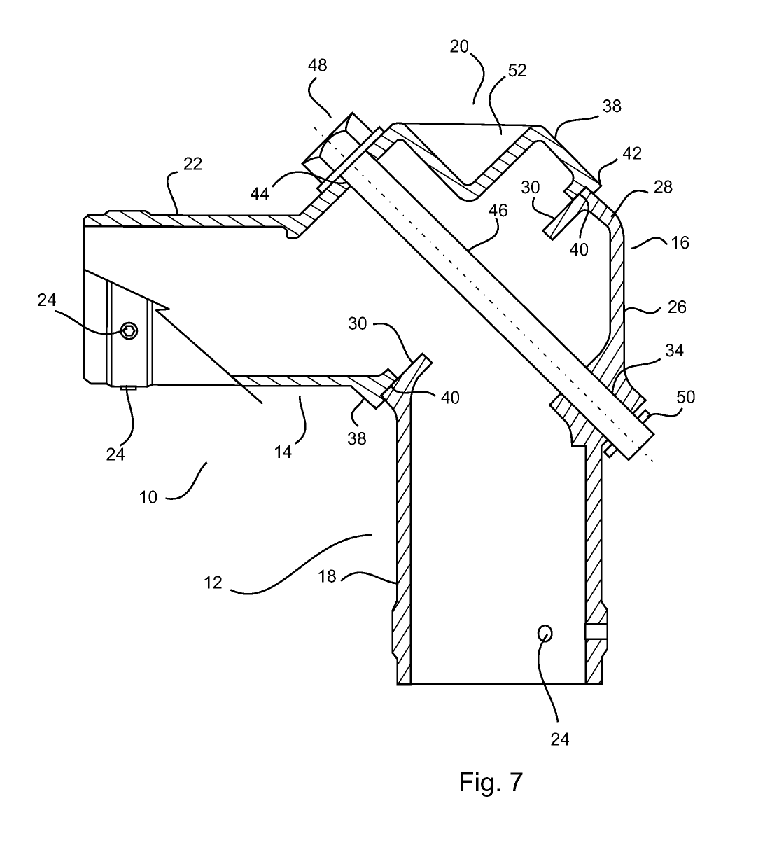

When maintenance on the light fitting is required, the bolt 46 may be loosened to a free configuration in which the compressive force between the bearing surfaces 30, 40 is not sufficient to prevent rotation of the second member 14 relative to the first member 12 about an axis defined by the bolt 46. Once the bolt 46 is in the free configuration, the lever 56 can be operated to withdraw the pin 54 from its aperture 32. This removes all impediments to rotation, and the second member 14 can be rotated, causing the second elongate leg 22 and its attached pole to swivel into its second position, substantially perpendicular to the first elongate leg 18. This is shown in FIGS. 2 and 7. Rotation will cease when the pin 54 locates within the next available aperture 32. Rotation can continue through repeated operation of the lever 56.

During rotation the bolt 46 continues to be held within the bolt receiving aperture 44, and it is anticipated that there will not be significant rotation of the bolt 46 as the second member 14 rotates relative to the first member 12. In the embodiment shown, the bolt receiving aperture 44 may be sized relative to a shaft of the bolt 46 such that the bolt 46 effectively acts as a supporting axle for the rotation. Alternatively, the shaft of the bolt 46 may be smaller than the bolt receiving aperture 44, in which case the bolt 46 merely represents an axis of rotation.

During rotation the bolt 46 continues to act to connect the first member 12 and the second member 14. The sleeve 42 and the outer edge of the cylindrical portion 28 of the first member 12 act in a fashion similar to a bearing bush, such that the second member 14 is supported by the first member 12 during rotation. In the embodiment shown the sleeve 42 extends only a short distance over the cylindrical portion 28. It will be appreciated that the second member 14 may be constructed with a significantly larger sleeve 42 to provide additional support.

When the swivelling joint 10 is in a desired configuration for maintenance, the bolt 46 can be tightened as an additional safety precaution, working in conjunction with the pin 54.

When maintenance is completed, the swivelling joint can be returned to the first position, with the bolt 46 tightened to its fixed configuration and the pin acting as a secondary locking mechanism.

It will be noted that in the embodiment described above the bearing surface 40 of the second member 14 acts directly against the bearing surface 30 of the first member 12. It may be possible to include intervening elements, such as rings, gaskets, seals or even roller bearing arrangements, without departing from the essential function of these surfaces to oppose each other.

Modifications and variations as would be apparent to a skilled addressee are deemed to be within the scope of the present invention. For instance, it is expected that the swivelling joint will include rotation limiting features to prevent 360° rotation.

1. A swivelling joint including a first member, a second member, and a connector;
the first member having a longitudinally extending leg and a connecting portion, the connecting portion including a bearing surface which is oriented at an acute angle relative to the longitudinally extending leg, the bearing surface having a circular outer edge;
the second member having a longitudinally extending leg and a connecting portion, the connecting portion including: a bearing surface which is oriented at an acute angle relative to the longitudinally extending leg, the bearing surface having a circular outer edge; and a cylindrical sleeve which projects from the circular outer edge in a direction generally perpendicular to the bearing surface;
the connector coupling the first and second members to each other such that the bearing surface of the first member bears against the bearing surface of the second member, with the sleeve of the second member locating around the circular outer edge of the bearing surface of the first member;
and wherein the connector permits rotation of the first member relative to the second member between a first position in which the longitudinally extending leg of the first member is parallel to the longitudinally extending leg of the second member and a second position in which the longitudinally extending leg of the first member is angled with respect to the longitudinally extending leg of the second member.

2. A swivelling joint including a first member, a second member, and a connector;
the first member having a longitudinally extending leg and a connecting portion, the connecting portion including a bearing surface which is oriented at an acute angle relative to the longitudinally extending leg, the bearing surface having an outer edge;
the second member having a longitudinally extending leg and a connecting portion, the connecting portion including: a bearing surface which is oriented at an acute angle relative to the longitudinally extending leg, the bearing surface having an outer edge; and a sleeve which projects from the outer edge;
the connector coupling the first and second members to each other such that the bearing surface of the first member faces the bearing surface of the second member, with the sleeve of the second member locating around the outer edge of the bearing surface of the first member;
and wherein the connector permits rotation of the first member relative to the second member between a first position in which the longitudinally extending leg of the first member is parallel to the longitudinally extending leg of the second member and a second position in which the longitudinally extending leg of the first member is angled with respect to the longitudinally extending leg of the second member.

3. A swivelling joint including a first member, a second member, and an axle;
the first member having a longitudinally extending leg and a connecting portion, the connecting portion including a bearing surface which is oriented at an acute angle relative to the longitudinally extending leg;
the second member having a longitudinally extending leg and a connecting portion, the connecting portion including a bearing surface which is oriented at an acute angle relative to the longitudinally extending leg;
the first and second members being coupled to each other such that the bearing surface of the first member faces the bearing surface of the second member;
the axle being arranged to pass through the connecting portion of the first member and the second member in a direction generally perpendicular to the bearing surface of the first member; and
the first and second members being coupled to each other so as to permit rotation of the first member relative to the second member about the axle between a first position in which the longitudinally extending leg of the first member is parallel to the longitudinally extending leg of the second member and a second position in which the longitudinally extending leg of the first member is angled with respect to the longitudinally extending leg of the second member.

4. A swivelling joint including a first member, a second member, and a connector;
the first member having a longitudinally extending leg and a connecting portion, the connecting portion including a bearing surface which is oriented at an acute angle relative to the longitudinally extending leg;
the second member having a longitudinally extending leg and a connecting portion, the connecting portion including a bearing surface which is oriented at an acute angle relative to the longitudinally extending leg;
the connector coupling the first and second members to each other such that the bearing surface of the first member bears against the bearing surface of the second member;
the connector permitting rotation of the first member relative to the second member between a first position in which the longitudinally extending leg of the first member is parallel to the longitudinally extending leg of the second member and a second position in which the longitudinally extending leg of the first member is angled with respect to the longitudinally extending leg of the second member;
wherein the connector is elongate, and defines an axis about which the relative rotation of first and second members can take place.

5. A swivelling joint as claimed in claim 1, wherein the acute angle formed by the bearing surface in the first member is the same as that formed by the bearing surface in the second member.

6. A swivelling joint as claimed in claim 5, wherein the acute angle is in the range 30° to 60°

7. A swivelling joint as claimed in claim 6, wherein the acute angle is 45°.

8. A swivelling joint as claimed in claim 1, wherein the connector is adjustable between a free configuration in which relative rotation of the first and second members is permitted and a fixed configuration in which relative rotation of the first and second members is restricted.

9. A swivelling joint as claimed in claim 8, wherein the connector in its fixed configuration provides a compressive force between the first and second members, urging the respective bearing surfaces into contact and using friction to restrict rotation.

10. A swivelling joint as claimed in claim 9, wherein the connector is formed by a bolt extending through an aperture in the first member and an aperture in the second member.

11. A swivelling joint as claimed in claim 10, wherein the bolt acts as an axle about which at least one of the first and second members may rotate when the connector is in the free configuration.

12. A swivelling joint as claimed in claim 10, wherein the bolt has a smaller diameter than at least one of the aperture in the first member and the aperture in the second member.

13. A swivelling joint as claimed in claim 1, wherein the bearing surfaces are annular.

14. A swivelling joint as claimed in claim 13, wherein the bearing surfaces have an internal diameter sized between 50% and 70% of the external diameter.

15. A swivelling joint as claimed in claim 1, wherein the swivelling joint includes a latch having a pin extending from one of the first and second members into a receptacle within the other of the first and second members.

16. A swivelling joint as claimed in claim 15, wherein the receptacle is provided as an aperture within the relevant bearing surface.

17. A swivelling joint as claimed in claim 16, wherein at least two apertures are provided, one corresponding to the first position of the swivelling joint and the other corresponding to the second position of the swivelling joint.

18. A swivelling joint as claimed in claim 15, wherein the pin is located within a pin housing, and moveable between an extended position in which it locates within a receptacle and a withdrawn position in which it is retracted from the receptacle to permit relative rotation of the first and second members.

19. A swivelling joint as claimed in claim 18, wherein resilient biasing means is provided to urge the pin into the extended position.

20. A swivelling joint as claimed in claim 18, wherein the pin housing includes means to translate rotation of an outer activator into linear movement of the pin.

21. A swivelling joint as claimed in claim 18, wherein the latch includes locking means formed by a projection from the pin, the projection arranged to move laterally of the pin to prevent retraction of the pin from the receptacle.
